(19) United States
(12) Patent Application Publication
(10) Pub. No.: US 2023/0139840 A1
(43) Pub. Date: May 4, 2023

(54) FRP Composite Spiral Stirrup Confined Concrete Column And Compression Design Method Thereof

(71) Applicants: Zhengzhou University, Zhengzhou City (CN); Henan Zhengda Building Materials Co., Ltd., Zhengzhou City (CN)

(72) Inventors: Pu Zhang, Zhengzhou City (CN); Junmin Hu, Zhengzhou City (CN); Jun Zhao, Zhengzhou City (CN); Danying Gao, Zhengzhou City (CN); Ye Liu, Zhengzhou City (CN); Shamim Ahmed Sheikh, Zhengzhou City (CN)

(21) Appl. No.: 17/975,700

(22) Filed: Oct. 28, 2022

(30) Foreign Application Priority Data
Oct. 29, 2021 (CN) 202111279342.8

(51) Int. Cl. E04C 5/07; E04C 3/34; G06F 30/13

(52) U.S. Cl. CPC E04C 5/073; E04C 3/34; G06F 30/13; G06F 2119/14

(57) ABSTRACT

The present disclosure discloses a Fiber Reinforced Polymer/Plastic (FRP) composite spiral stirrup confined concrete column and a compression design method. The FRP composite spiral stirrup includes an internal FRP spiral stirrup and an external FRP square stirrup. In the form of the FRP composite spiral stirrup, effective transverse stress transfer is established by effectively binding stirrups, which can give full play to the mechanical properties of the FRP bars, provide “dual confinement” for core concrete, and greatly improve the peak stress of the core concrete. Confining mechanisms of the FRP composite spiral stirrup to the concrete in different areas are analyzed, a confinement model and a bearing capacity calculation method for the FRP composite spiral stirrup confined concrete column are proposed, and a design method for the FRP composite spiral stirrup confined concrete column is proposed after an accurate calculation method for the bearing capacity is obtained.

### TECHNICAL FIELD

The present disclosure belongs to the technical field of civil engineering, and particularly, relates to a Fiber Reinforced Polymer/Plastic (FRP) composite spiral stirrup confined concrete column and a compression design method thereof.

### BACKGROUND

Reinforced concrete columns have the problems of great structural self-weight during application, poor durability in harsh environments, and the like. With the increase of the service life of a structure, corrosive ions such as chloride ions in the harsh environments such as a marine environment and a chemical plant penetrate into a member through a crack to cause the rusting and the corrosion of steel bars, which reduces the durability of the structure. In addition, with regard to the principle of “strong column and weak beam” in seismic requirements, it is also an urgent problem to improve the bearing capacity and the ductility of a column on the premise of good durability.

A marine concrete building must be solid, safe, durable, and economic. However, marine concrete is often destroyed prematurely due to a combined action of a plurality of factors such as chloride ion erosion, sulfate erosion, carbonization, microbial corrosion, and sea wave erosion and abrasion caused by frequent dry-wet alternation and storms, which greatly shortens the service life of the structure, and the problem of durability is to be solved urgently.

An FRP bar has been considered by domestic and foreign scholars to solve the problems of rusting and corrosion of steel bars in a harsh environment instead of steel bars due to the advantages of light weight, high strength, corrosion resistance, excellent fatigue resistance, and the like. However, the brittle failure of the FRP reinforced concrete column often occurs due to insufficient ductility, which limits the popularization and application of the FRP reinforced concrete column.

A stirrup provides a confining effect for core concrete, which can improve the ductility of a column. At present, the research on the compression performance of the FRP reinforced concrete column is mainly in the form of stirrups. The lateral pressure generated by an FRP spiral stirrup is distributed evenly, and there is no arch-shaped “ineffective confinement area”, so the confining effect is strong. However, when the FRP spiral stirrup is used for a common concrete column with a square cross section in engineering, concrete at corners thereof cannot be confined, which results in limited applications. An FRP square stirrup may be used for the concrete column with the square cross section, but the confinement provided by the same is distributed unevenly, and there is an arch-shaped “ineffective confinement area”, so the confining effect is relatively weak. It is necessary to provide a new stirrup form which has a strong confining effect and is applicable to an actual practical engineering application.

The Chinese invention patent “CFRP (BFRP) longitudinal bar-GFRP composite stirrup square pipe pile and design method” (Publication No. CN111287179A) discloses a CFRP (BFRP) longitudinal bar-GFRP composite stirrup square pipe pile and a design method, which improves the bearing and anti-cracking capacity of a column by using composite stirrups and pre-stressed bars, and is applied to corrosive areas such as oceans. However, since a square stirrup is far away from a spiral stirrup, the concrete therein cannot be confined. Moreover, an uplift pile is proposed, and the compression bearing capacity thereof needs to be accurately evaluated for a frame column. Therefore, it is necessary to understand a calculation model and a calculation method for the compression bearing capacity of the composite spiral stirrup confined column.

### SUMMARY

An objective of the present disclosure is to apply corrosion-resistant FRP bars to overcome a harsh marine environment and ensure the durability of a structure. In order to improve the confinement of the concrete in a core area, a stirrup form, such as a composite stirrup, that can provide dual confinement is proposed. An FRP composite spiral stirrup confined concrete column is designed as follows, and a calculation model and a calculation method for the compression bearing capacity of the composite spiral stirrup confined concrete column are given.

In order to solve the above technical problems, the technical solution adopted by the present disclosure is as follows:

An FRP composite spiral stirrup confined concrete column includes an FRP composite spiral stirrup 1, longitudinal bars 2, and concrete 3. The longitudinal bars 2 include a central longitudinal bar 2-1 and corner longitudinal bars 2-2. The central longitudinal bar 2-1 is bound with the FRP composite spiral stirrup 1, and the corner longitudinal bars 2-1 are bound with a square stirrup to form a reinforcement skeleton. The reinforcement skeleton is arranged in the concrete 3.

The FRP composite spiral stirrup 1 includes an internal FRP spiral stirrup 1-1 and an external FRP square stirrup 1-2. The diameter of the internal FRP spiral stirrup 1-1 is equal to the side length of the external FRP square stirrup 1-2. Each circle of FRP spiral stirrup is bound with an FRP square stirrup.

Longitudinal bars are also evenly distributed at the corners of the FRP square stirrup.

The FRP square stirrup and the FRP spiral stirrup use one or more of Glass Fiber Reinforced Polymer/Plastic (GFRP) bars, Carbon Fiber Reinforced Polymer/Plastic (CFRP) bars, Basalt Fiber Reinforced Polymer/Plastic (BFRP) bars, and Aramid Fiber Reinforced Polymer/Polymer (AFRP) bars.

The longitudinal bars use one of steel bars, the GFRP bars, the CFRP bars, the BFRP bars, and the AFRP bars, or mixed bars of the steel bars and FRP bars.

A compression design method for the FRP composite spiral stirrup confined concrete column includes the following steps:
step one: applying the column to a marine environment, so as to determine the environment type of an area where the column is located and the action grade thereof, and perform a durability design on members under different design service lives and corresponding limit states;
step two: working out an overall scheme and a structural form according to design requirements, and preliminarily determining sectional dimensions of the FRP composite spiral stirrup confined concrete column with reference to the existing design and relevant data;
step three: calculating the maximum design bearing capacity of a control cross section of the column under the design service life and the limit state according to the worked outbuilding scale of a building structure, the position where the column is located, and a set load feature;
step four: preliminarily working out the configurations of longitudinal bars and stirrups according to the preliminarily worked out sectional dimensions, the maximum design bearing capacity under the limit state, and the reinforcement requirements in a specification;
step five: determining effective lateral confinement stresses of the internal FRP spiral stirrup and the external FRP square stirrup; and
step six: making a composite spiral stirrup confinement model, and calculating the limit bearing capacity of the FRP composite spiral stirrup confined concrete column.

In step five, a formula for calculating the effective lateral confinement stress of the FRP spiral stirrup is as follows:

$${f}_{1}^{'} = {k}_{\text{e}} \frac{2 {f}_{\text{fb}} {A}_{\text{f}}}{S {d}_{\text{s}}}$$

In the formula, f_{fb} is a smaller value of the bending strength of the spiral stirrup and 0.004E_{ft}, and E_{ft} is the tensile modulus of elasticity of a reinforcement material; A_{f} is the sectional area of the spiral stirrup;
S is the spacing between stirrups;
dₛ is the diameter between the middle lines of the spiral stirrups;
kₑ is an effective confinement coefficient;
a formula for calculating the effective confinement coefficient kₑ of the FRP spiral stirrup is as follows:

$${k}_{\text{e}} = \frac{{A}_{\text{e}}}{{A}_{\text{cc}}} = \frac{\text{1-} \frac{{S}^{'}}{2 {d}_{\text{s}}}}{1 - {ρ}_{\text{cc}}}$$

In the formula, A_{cc} is the area of the concrete enclosed by the middle lines of the spiral stirrups and does not include the area of the longitudinal bars;
Aₑ is the area of the effectively confined core concrete;
S′ is the clear distance between stirrups; and
p_{cc} is the ratio of the area of the longitudinal bars to the sectional core area.

In step five, for the FRP square stirrup, the lateral confinement stress generated by the same in a horizontal plane is unevenly distributed; a confining force reaches the maximum at the longitudinal bar; an arch-shaped “ineffective confinement area” between two adjacent longitudinal bars is in a quadratic parabola shape; the area of the parabola is wᵢ²/6 , where wᵢ is the clear distance between the two adjacent longitudinal bars; the square stirrup also has an arch-shaped “ineffective confinement area” in the vertical direction;
so, for the FRP square stirrup, a process for calculating the effective lateral confinement stress f₂’ is as follows:
$${f}_{2}^{'} = \frac{{f}_{\text{1} \text{} \text{x}}^{'} + {f}_{\text{1} \text{} \text{y}}^{'}}{2}$$
where,
$${f}_{1 \text{} \text{x}}^{'} = {k}_{\text{e}} {ρ}_{\text{x}} {f}_{\text{fb}} = {k}_{\text{e}} \frac{{A}_{\text{sx}}}{S {d}_{\text{c}}} {f}_{\text{fb}}$$
$${f}_{1 \text{} \text{y}}^{'} = {k}_{\text{e}} {ρ}_{\text{y}} {f}_{\text{fb}} = {k}_{\text{e}} \frac{{A}_{\text{sy}}}{S {b}_{\text{c}}} {f}_{\text{fb}}$$

In the formula, fₗₓ’ is an effective lateral confinement stress in an x direction;
fₗₓ’ is an effective lateral confinement stress in a y direction;
Aₛₓ is the total area of the stirrup in the x direction;
A_{sy} is the total area of the stirrup in the y direction;
b_{c} and d_{c} are distances of centerlines of the rectangular stirrup in two directions, respectively, where b_{c} ≥ d_{c};
a formula for calculating the effective confinement coefficient kₑ of the FRP square stirrup is as follows:

$${k}_{\text{e}} = \frac{{A}_{\text{e}}}{{A}_{\text{cc}}} = \frac{\left(1 - {\sum }_{i = 1}^{n} \frac{{w}_{i}^{2}}{6 {b}_{\text{c}} {d}_{\text{c}}}\right) \left(1 - \frac{{S}^{'}}{2 {b}_{\text{c}}}\right) \left(1 - \frac{{S}^{'}}{2 {d}_{\text{c}}}\right)}{\left(1 \text{-} {ρ}_{\text{cc}}\right)}$$

In the formula, n is the number of the longitudinal bars.

In step six, when the composite spiral stirrup confinement model is made, in order to accurately reflect the actual confining effect of each stirrup, a composite spiral stirrup confinement area is divided into a dual confinement area and a single confinement area to accurately reflect the actual confining effect of each stirrup,

where the dual confinement area is an area inside the spiral stirrup, and the single confinement area is an area from the spiral stirrup to the square stirrup; and a peak stress expression of the concrete in the dual confinement area is as follows:

$${f}_{c c 1} = {f}_{c o} \left(1.0 + 3.897 {\left(\frac{{f}_{d}^{'}}{{f}_{\text{co}}}\right)}^{0.737}\right)$$

In the formula, f_{cc1} is the peak stress of the concrete in the dual confinement area;
f_{co} is the strength of confined concrete;
f_{d}’ is the sum of the effective lateral confinement stresses of the spiral stirrup and the rectangular stirrup; and
a peak stress expression of the concrete in the single confinement area is as follows:

$${f}_{c c 2} = {f}_{c o} \left(2.254 \sqrt{1 + \frac{7.94 {f}_{2} '}{{f}_{c o}}} - 2 \frac{{f}_{2} '}{{f}_{c o}} - 1.254\right)$$

In the formula, f_{cc2} is the peak stress of the concrete in the single confinement area;
f_{co} is the strength of the confined concrete;
f₂’ is an effective lateral confinement stress of the FRP rectangular stirrup; and
finally, a formula for calculating the bearing capacity of the FRP composite spiral stirrup confined concrete column is as follows:

$${P}_{0} = {f}_{c c 1} \left({A}_{1} - {n}_{1} {A}_{b a r}\right) + {f}_{c c 2} \left({A}_{2} - {n}_{2} {A}_{b a r}\right) + n {ε}_{b a r} {E}_{b a r} {A}_{b a r}$$

In the formula, P₀ is the bearing capacity of the FRP composite spiral stirrup confined concrete column;
f_{cc1} is the peak stress of the concrete in the dual confinement area;
A₁ is the area of the dual confinement area;
n₁ is the number of the longitudinal bars of the dual confinement area;
f_{cc2} is the peak stress of the con concrete in the single confinement area;
A₂ is the area of the single confinement area;
n₂ is the number of the longitudinal bars in the single confinement area;
A_{bar} is the sectional area of a single longitudinal bar;
n is the total number of the longitudinal bars;
ε_{bar} is the limit compressive strain of the FRP bar; and
E_{bar} is the modulus of elasticity of the FRP bar.

The values of the limit compressive strains ε_{bar} of the FRP bar are taken as 1.3%, 1.2%, and 0.7% according to the slenderness ratios of 6, 10, and 15, and the values of other slenderness ratios are taken according to interpolation.

The present disclosure has the following beneficial effects.
(1) After a steel stirrup in the conventional reinforced concrete reaches the yield strength, the confining effect of the steel stirrup on core concrete will not increase. The FRP bar has the characteristic of linear elasticity. The confining effect generated by the FRP stirrup increases continuously with lateral expansion of the concrete until the FRP stirrup is broken, which can give full play to the confining performance of the FRP stirrup on the core concrete.
(2) Circumferential lateral confining force is provided by using the internal spiral stirrup, and a square stirrup is arranged externally, which can not only change the cross section into a square to enlarge the application range of the column, but also work together with the internal spiral stirrup to realize dual confinement on the core concrete.
(3) A general calculation model for the spiral stirrup column cannot accurately reflect the confining effect of the FRP composite spiral stirrup. A composite spiral stirrup confinement model is proposed through theoretical and test data analysis, the confining mechanisms of the composite spiral stirrup on the concrete in different areas are analyzed, and a design method for the FRP composite spiral stirrup confined concrete column is provided.
(4) According to the FRP composite spiral stirrup confined concrete column provided by the present disclosure, the form of the FRP composite spiral stirrup can provide dual confinement for the core concrete, which greatly improves the peak stress of the core concrete, thereby improving the bearing capacity and the ductility of the concrete column, and solving the problem of brittle failure caused by insufficient ductility during using the FRP reinforced concrete column.
(5) According to the FRP composite spiral stirrup confined concrete column provided by the present disclosure, compared with the conventional reinforced concrete column, the problems of rusting and corrosion of steel bars in harsh environments such as a marine environment and a chemical plant can be solved by the FRP bars, which is of great significance to improve the durability of the concrete column.
(6) A general calculation model for the spiral stirrup column cannot accurately reflect the confining effect of the FRP composite spiral stirrup. However, the present disclosure proposes a composite spiral stirrup confinement model through theoretical and test data analysis, analyzes the confining mechanisms of the composite spiral stirrup on the concrete in different areas, and provides a design method for the FRP composite spiral stirrup confined concrete column.
(7) The FRP composite spiral stirrup confined concrete column provided by the present disclosure is simple in process and easy to operate, and facilitates the popularization and use in engineering application.

### BRIEF DESCRIPTION OF THE DRAWINGS

FIG. 1 is a schematic structural diagram of the present disclosure;

FIG. 2 is a sectional view of an A-A directional plane in FIG. 1;

FIG. 3 is a transverse sectional view of an effective lateral confinement stress of an FRP spiral stirrup in the present disclosure;

FIG. 4 is a longitudinal partial sectional view of the effective longitudinal confinement stress of the FRP spiral stirrup in the present disclosure;

FIG. 5 is a transverse sectional view of the effective lateral confinement stress of an FRP square stirrup in the present disclosure;

FIG. 6 is a longitudinal partial sectional view of an effective longitudinal confinement stress of the FRP square stirrup in the present disclosure; and

FIG. 7 is a schematic diagram of a confinement area of the composite spiral stirrup in the present disclosure.

### DETAILED DESCRIPTION OF THE EMBODIMENTS

Implementation modes of the present disclosure are described below through particular and specific embodiments. Other advantages and effects of the present disclosure can be easily understood by those skilled in the art from the content disclosed in the present specification.

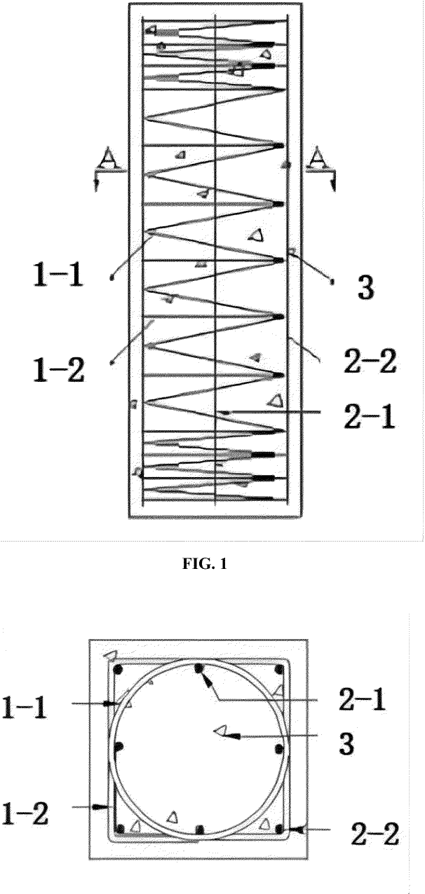

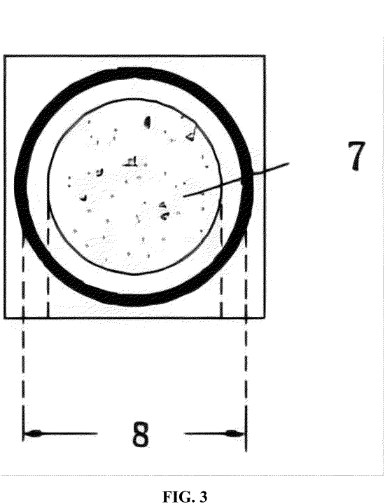

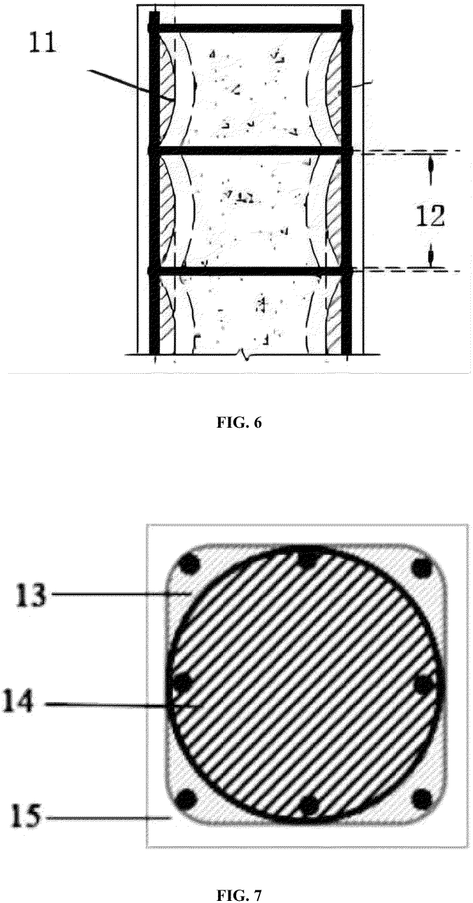

The present disclosure provides an FRP composite spiral stirrup confined concrete column and a compression design method thereof, as shown in FIG. 1 to FIG. 7.

An FRP composite spiral stirrup confined concrete column includes an FRP composite spiral stirrup 1, longitudinal bars 2, and concrete 3. The longitudinal bars 2 include a central longitudinal bar 2-1 and corner longitudinal bars 2-2. The central longitudinal bar 2-1 is bound with the FRP composite spiral stirrup 1, and the corner longitudinal bars 2-1 are bound with a square stirrup to form a reinforcement skeleton. The reinforcement skeleton is arranged in the concrete 3. The FRP composite spiral stirrup 1 includes an internal FRP spiral stirrup 1-1 and an external FRP square stirrup 1-2. The diameter of the internal FRP spiral stirrup 1-1 is equal to the side length of the external FRP square stirrup 1-2. Each circle of FRP spiral stirrup is bound with an FRP square stirrup. Circumferential lateral confining force is provided by using the internal spiral stirrup, and a square stirrup is arranged externally, which can not only change the cross section into a square to enlarge the application range of the column, but also work together with the internal spiral stirrup to realize “dual confinement”.

The FRP square stirrup 1-1 and the FRP spiral stirrup 1-2 use one or more of Glass Fiber Reinforced Polymer/Plastic (GFRP) bars, Carbon Fiber Reinforced Polymer/Plastic (CFRP) bars, Basalt Fiber Reinforced Polymer/Plastic (BFRP) bars, and Aramid Fiber Reinforced Polymer/Plastic (AFRP) bars. The longitudinal bars use steel bars, the GFRP bars, the CFRP bars, the BFRP bars, and the AFRP bars, or mixed reinforcing bars of the steel bars and the FRP bars. According to the corrosive environment conditions of the working conditions from ordinary to severe, the steel bars, mixed reinforcing bars of the steel bars and the FRP, and full FRP longitudinal bars are selected in sequence, so as to meet the requirement of durability, and reduce the structural cost.

A compression design method for the FRP composite spiral stirrup confined concrete column includes the following steps.

Step one: the column is applied to a marine environment, so as to determine the environment type of an area where the column is located and the action grade thereof, and perform a durability design on members under different design service lives and corresponding limit states.

Step two: an overall scheme and a structural form are worked out according to design requirements, and sectional dimensions of the FRP composite spiral stirrup confined concrete column are determined preliminarily with reference to the existing design and relevant data.

Step three: the maximum design bearing capacity of a control cross section of the column under the design service life and the limit state is calculated according to the worked outbuilding scale of a building structure, the position where the column is located, and a set load feature.

Step four: the configurations of longitudinal bars and stirrups are worked out preliminarily according to the preliminarily worked out sectional dimensions, the maximum design bearing capacity under the limit state, and the reinforcement requirements in a specification.

Step five: effective lateral confinement stresses of the internal FRP spiral stirrup and the external FRP square stirrup are determined.

Step six: a composite spiral stirrup confinement model is made, and the limit bearing capacity of the FRP composite spiral stirrup confined concrete column is calculated.

In step five, the effective lateral confinement stresses of the internal FRP spiral stirrup and the external FRP square stirrup are calculated. In order to express the confining effect of the stirrup more accurately, the effective lateral confinement stresses of the two stirrups are respectively calculated according to the situation that both the spiral stirrup confined concrete and the square stirrup confined concrete have an effective confinement area, as shown in FIG. 3.

Firstly, for the effective lateral confinement stress of the FRP spiral stirrup, the radial pressure generated by the FRP spiral stirrup in the horizontal plane is evenly distributed, and the FRP spiral stirrup has an arch-shaped “ineffective confinement area” in the vertical direction, and the boundary of the ineffective confinement area is in a quadratic parabola shape. Therefore, a formula for calculating the effective lateral confinement stress fl′ of the FRP spiral stirrup is as follows:

$${f}_{1}^{'} = {k}_{\text{e}} \frac{2 {f}_{\text{fb}} {A}_{\text{f}}}{S {d}_{\text{s}}}$$

In the formula, f_{fb} is a smaller value of the bending strength of the spiral stirrup and 0.004E_{ft};
A_{f} is the sectional area of the spiral stirrup;
S is the spacing between stirrups;
dₛ is the diameter between the middle lines of the spiral stirrups;
kₑ is an effective confinement coefficient;
a formula for calculating the effective confinement coefficient kₑ of the FRP spiral stirrup is as follows:

$${k}_{\text{e}} = \frac{{A}_{\text{e}}}{{A}_{\text{cc}}} = \frac{\text{1-} \frac{{S}^{'}}{2 {d}_{\text{s}}}}{1 - {ρ}_{\text{cc}}}$$

In the formula, A_{cc} is the area of the concrete enclosed by the middle lines of the spiral stirrups and does not include the area of the longitudinal bars;
Aₑ is the area of the effectively confined core concrete;
S′ is the clear distance between stirrups; and
p_{cc} is the ratio of the area of the longitudinal bars to the sectional core area.

Secondly, for the FRP square stirrup, the lateral confinement stress generated by the same in a horizontal plane is unevenly distributed; a confining force reaches the maximum at the longitudinal bar; an arch-shaped “ineffective confinement area” between two adjacent longitudinal bars is in a quadratic parabola shape; the area of the parabola is wᵢ²/6, where wᵢ is the clear distance between the two adjacent longitudinal bars; and a rectangular stirrup also has an arch-shaped “ineffective confinement area” in the vertical direction.

So, for the FRP square stirrup, the effective lateral confinement stress f₂’ of the FRP square stirrup can be calculated according to the following formula::

$${f}_{2}^{'} = \frac{{f}_{\text{1} \text{} \text{x}}^{'} + {f}_{\text{1} \text{} \text{y}}^{'}}{2}$$

where,

$${f}_{1 \text{} \text{x}}^{'} = {k}_{\text{e}} {ρ}_{\text{x}} {f}_{\text{fb}} = {k}_{\text{e}} \frac{{A}_{\text{sx}}}{S {d}_{\text{c}}} {f}_{\text{fb}}$$

$${f}_{1 \text{} \text{y}}^{'} = {k}_{\text{e}} {ρ}_{\text{y}} {f}_{\text{fb}} = {k}_{\text{e}} \frac{{A}_{\text{sy}}}{S {b}_{\text{c}}} {f}_{\text{fb}}$$

In the formula, fₗₓ’ is an effective lateral confinement stress in an x direction;
f_{ly}’ is an effective lateral confinement stress in a y direction;
Aₛₓ is the total area of the stirrup in the x direction;
A_{sy} is the total area of the stirrup in the y direction;
b_{c} and d_{c} are distances of centerlines of the rectangular stirrup in two directions, respectively, where b_{c} ≥ d_{c};
a formula for calculating the effective confinement coefficient kₑ of the FRP square stirrup is as follows:

$${k}_{\text{e}} = \frac{{A}_{\text{e}}}{{A}_{\text{cc}}} = \frac{\left(1 - {\sum }_{i = 1}^{n} \frac{{w}_{i}^{2}}{6 {b}_{\text{c}} {d}_{\text{c}}}\right) \left(1 - \frac{{S}^{'}}{2 {b}_{\text{c}}}\right) \left(1 - \frac{{S}^{'}}{2 {d}_{\text{c}}}\right)}{\left(1 \text{-} {ρ}_{\text{cc}}\right)}$$

In the formula, n is the number of the longitudinal bars.

In step six, when the composite spiral stirrup confinement model is made, confining mechanisms of the two types of stirrups to the concrete in different areas are analyzed, and a method for calculating the bearing capacity of the composite spiral stirrup confined column is proposed.

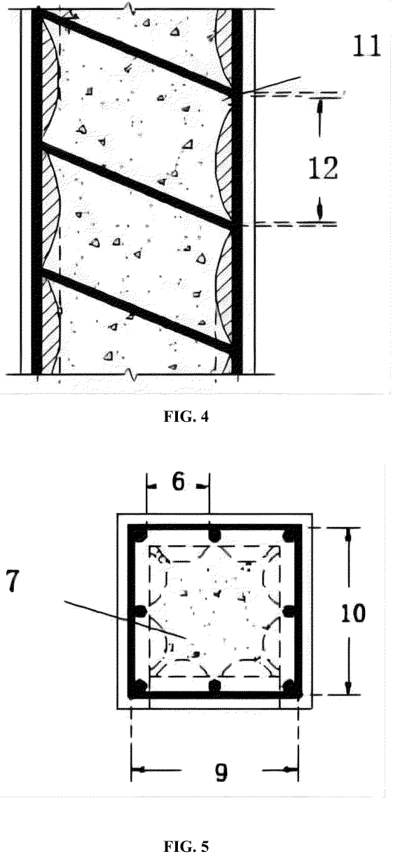

The composite spiral stirrup confinement model: a composite stirrup confinement area is innovatively divided into a dual confinement area (i.e., an area inside a spiral stirrup, an area 14 as shown in FIG. 4) and a single confinement area (i.e., an area from the spiral stirrup to the rectangular stirrup, an area 13 as shown in FIG. 4), such that an actual confining effect of each stirrup can be reflected accurately. By the confinement model as shown in FIG. 4, the contribution of different confinement areas to the bearing capacity of the column is calculated separately.

For the peak stress of the concrete in the dual confinement area, the ratio f_{cc} / f_{co} of the peak stress of the confined concrete to the peak stress of the unconfined concrete has a strong nonlinear correlation with the confining ratio fₗ′/ f_{co}. Fitting is performed according to test data, so as to obtain a peak stress expression of the FRP stirrup confined concrete strength model:

$${f}_{c c 1} = {f}_{c o} \left(1.0 + 3.897 {\left(\frac{{f}_{d}^{'}}{{f}_{\text{co}}}\right)}^{0.737}\right)$$

In the formula, f_{cc1} is the peak stress of the concrete in the dual confinement area;
f_{co} is the strength of unconfined concrete; and
f_{d}’ is the sum of the effective lateral confinement stresses of the spiral stirrup and the rectangular stirrup.

For the peak stress of concrete in the single confinement area: in the single confinement area, the concrete is only confined by the rectangular stirrup; the effective lateral confinement stresses in two directions of a cross section are the same; and a formula for calculating the peak stress of the stirrup confined concrete is as follows:

$${f}_{c c 2} = {f}_{c o} \left(2.254 \sqrt{1 + \frac{7.94 {f}_{2} '}{{f}_{c o}}} - 2 \frac{{f}_{2} '}{{f}_{c o}} - 1.254\right)$$

In the formula, f_{cc2} is the peak stress of the concrete in the single confinement area;
f_{co} is the strength of unconfined concrete; and
f₂’ is an effective lateral confinement stress of the FRP rectangular stirrup.

Finally, the bearing capacity of the composite spiral stirrup confined column considers the contribution of three pieces of concrete with different confining effects and longitudinal bars. A formula for calculating the bearing capacity P₀ of the FRP composite spiral stirrup confined concrete column is as follows:

$${P}_{0} = {f}_{c c 1} \left({A}_{1} - {n}_{1} {A}_{b a r}\right) + {f}_{c c 2} \left({A}_{2} - {n}_{2} {A}_{b a r}\right) + n {ε}_{b a r} {E}_{b a r} {A}_{b a r}$$

In the formula, P₀ is the bearing capacity of the FRP composite spiral stirrup confined concrete column;
f_{cc1} is the peak stress of the concrete in the dual confinement area;
A₁ is the area of the dual confinement area;
n₁ is the number of the longitudinal bars of the dual confinement area;
f_{cc2} is the peak stress of the con concrete in the single confinement area;
A₂ is the area of the single confinement area;
n₂ is the number of the longitudinal bars in the single confinement area;
A_{bar} is the sectional area of a single longitudinal bar;
n is the total number of the longitudinal bars;
ε_{bar} is the limit compressive strain of the FRP bar; and
E_{bar} is the modulus of elasticity of the FRP bar.

Where, ε_{bar} is the limit compressive strain of the FRP bar. The values of the limit compressive strains are 1.3%, 1.2%, and 0.7% according to the slenderness ratios of 6, 10, and 15, and the values of other slenderness ratios are taken according to interpolation. E_{bar} is the modulus of elasticity of the FRP bar, and the value thereof is 46.3 GPa.

A method for pouring the FRP composite spiral stirrup confined concrete column is as follows:

First, the FRP spiral stirrup (1-1) is bound to the central longitudinal bar (2-1), and simultaneously, the spacing between the FRP spiral stirrups is adjusted according to a design requirement. Then, the FRP square stirrup (1-2) is bounded, and finally, the corner longitudinal bars (2-2) are bound to the corners of the FRP square stirrup (1-2). Therefore, reinforcement skeleton with the confinement of the FRP composite spiral stirrups is obtained.

In the present embodiment, in order to ensure that the concrete between the FRP spiral stirrup (1-1) and the FRP square stirrup (1-2) is also effectively confined. The FRP square stirrup is a closed stirrup, and is formed by lapping two ends. A lap joint is located at a right angle of the square stirrup. The four bending angles are all 90°. The lapping length needs to be 12 times greater than the diameter of the stirrup, so as to meet the effective lapping length, and ensure that the FRP square stirrup 2 can provide effective confinement under a high stress.

High-strength concrete (3) is the concrete with the compressive strength of C60, and in order to support a framework for the bound reinforcement skeleton, the set thickness of a protective layer reserved at an edge is 25 mm. The high-strength concrete 3 may be poured in a vertical or horizontal mode.

The FRP bars are selected from GFRP bars, which have the characteristics of light weight, high strength, corrosion resistance, fatigue resistance, and higher cost performance relative to other FRP bars.

According to the actual design requirements, proper diameter of the FRP bar and dimensions of the spiral stirrup and the square stirrup are selected, and the diameter of the FRP spiral stirrup is equal to the side length of the FRP square stirrup (±5 mm), which can ensure accurate binding of the two types of stirrups, thereby providing “dual confinement” for the core concrete, and improving the bearing capacity and the ductility of the concrete column.

The accuracy of the method for calculating the bearing capacity the FRP composite spiral stirrup confined concrete column proposed by the present disclosure is further proved below by design examples.

In order to avoid the eccentric pressure of a column body caused by a long column, the dimensions of column to be designed is 300 mm×300 mm×900 mm, the thickness of the protective layer is 25 mm, the longitudinal bars are eight GFRP bars with the diameter of 16 mm; the diameter of the GFRP stirrup is 8 mm; and the spacing between the stirrups is 50, 100, and 150 mm. The form of a composite spiral stirrup (internal spiral stirrups and external rectangular spiral stirrups) is used. The concrete strength grade is C60.

Now, two traditional calculation methods for calculating a spiral stirrup column and the calculation method proposed by the present disclosure are used for comparative analysis, and the accuracy is verified by corresponding test data:

First, a formula for overall calculation of the bearing capacity of the column and a calculation result without considering a confinement area are as follows:

$${P}_{0} = 0.85 {{f}^{′}}_{c} \left({A}_{g} - {A}_{s}\right) + 0.02 {E}_{f} {A}_{s}$$

In the formula, f_{c}’ is the effective lateral confinement stress of the spiral stirrup and the rectangular stirrup; A_{g} is the sectional area; Aₛ is the sectional area of a longitudinal bar; and E_{f} is a modulus of elasticity of the GFRP longitudinal bar.

It is calculated that the bearing capacity of the column is 3241KN under the three stirrup spacings of 50 mm, 100 mm, and 150 mm.

Second, a calculation formula and a result obtained by using the effective confinement model of the spiral stirrup without distinguishing the dual confinement area and the single confinement area are as follows:

$${P}_{0} = {f}_{c c 1} \left({A}_{1} - n {A}_{b a r}\right) + n {ε}_{b a r} {E}_{b a r} {A}_{b a r}$$

f_{cc1} In the formula, f_{cc1} is to perform even summation on the effective lateral confinement stresses of a simple spiral stirrup and the rectangular stirrup.

It is calculated that the bearing capacity of the column is 5296KN, 4383KN, and 4136KN respectively under the three stirrup spacings of 50 mm, 100 mm, and 150 mm.

Third, a formula and a calculation result obtained by using the composite spiral stirrup confinement model proposed by the present disclosure and distinguishing the actual confining effects of different areas are as follows:

$${P}_{0} = {f}_{c c 1} \left({A}_{1} - {n}_{1} {A}_{b a r}\right) + {f}_{c c 2} \left({A}_{2} - {n}_{2} {A}_{b a r}\right) + n {ε}_{b a r} {E}_{b a r} {A}_{b a r}$$

It is calculated that the bearing capacity of the column is 4926KN, 4006KN, and 3843KN respectively under the three stirrup spacings of 50 mm, 100 mm, and 150 mm.

It is calculated that the bearing capacity of the column is 5016KN, 4083KN, and 3943KN respectively under the three stirrup spacings of 50 mm, 100 mm, and 150 mm.

It can be known from the comparison with the test data that the average errors of the three calculation methods under different stirrup spacings are respectively 75.39%, 106.5%, and 97.93%. Therefore, the bearing capacity calculated by using the composite spiral stirrup confinement model proposed by the present disclosure is the most accurate, and a smaller value is beneficial to retaining the bearing allowance for the practical engineering.

Finally, it is to be noted that the above embodiments are merely used to illustrate the technical solutions of the present disclosure, and are not intended to limit the present disclosure. Although the present disclosure has been described in detail with reference to the foregoing embodiments, those of ordinary skill in the art should understand that the technical solutions described in the foregoing embodiments are modified, or some technical features are equivalently replaced. However, these modifications and replacements do not make the essence of the corresponding technical solutions depart from the spirit and scope of the technical solutions of various embodiments of the present disclosure.

In the descriptions of the present disclosure, it is to be understood that an orientation or positional relationship indicated by the terms “front”, “back”, “left”, “right”, “center”, and the like is an orientation or positional relationship shown in the drawings, and is merely for the convenience of describing the present disclosure and simplifying the description, rather than indicating or implying that the device or elements referred to have a particular orientation, and configure and operate for the particular orientation. Thus, it cannot be construed as limiting the scope of protection of the present disclosure.

1. A Fiber Reinforced Polymer/Plastic (FRP) composite spiral stirrup confined concrete column, comprising: an FRP composite spiral stirrup (1), longitudinal bars (2), and concrete (3), wherein the longitudinal bars (2) comprise a central longitudinal bar (2-1) and corner longitudinal bars (2-2); the central longitudinal bar (2-1) is bound with the FRP composite spiral stirrup (1), and the corner longitudinal bars (2-2) are bound with a square stirrup to form a reinforcement skeleton; the reinforcement skeleton is arranged in the concrete (3);
the FRP composite spiral stirrup (1) comprises an internal FRP spiral stirrup (1-1) and an external FRP square stirrup (1-2); the diameter of the internal FRP spiral stirrup (1-1) is equal to the side length of the external FRP square stirrup (1-2); each circle of FRP spiral stirrup is bound with an FRP square stirrup; and
the longitudinal bars are also evenly distributed at the corners of the FRP square stirrup.

2. The FRP composite spiral stirrup confined concrete column according to claim 1, wherein the FRP square stirrup and the FRP spiral stirrup use one or more of Glass Fiber Reinforced Polymer/Plastic (GFRP) bars, Carbon Fiber Reinforced Polymer/Plastic (CFRP) bars, Basalt Fiber Reinforced Polymer/Plastic (BFRP) bars, and Aramid Fiber Reinforced Polymer/Plastic (AFRP) bars.

3. The FRP composite spiral stirrup confined concrete column according to claim 1, wherein the longitudinal bars use one of steel bars, the GFRP bars, the CFRP bars, the BFRP bars, and the AFRP bars, or mixed bars of the steel bars and FRP bars.

4. A compression design method for the FRP composite spiral stirrup confined concrete column according to claim 1, comprising the following steps:
step one: applying the column to a marine environment, so as to determine the environment type of an area where the column is located and the action grade thereof, and perform a durability design on members under different design service lives and corresponding limit states;
step two: working out an overall scheme and a structural form according to design requirements, and preliminarily determining sectional dimensions of the FRP composite spiral stirrup confined concrete column with reference to the existing design and relevant data;
step three: calculating the maximum design bearing capacity of a control cross section of the column under the design service life and the limit state according to the worked outbuilding scale of a building structure, the position where the column is located, and a set load feature;
step four: preliminarily working out the configurations of longitudinal bars and stirrups according to the preliminarily worked out sectional dimensions, the maximum design bearing capacity under the limit state, and the reinforcement requirements in a specification;
step five: determining effective lateral confinement stresses of the internal FRP spiral stirrup and the external FRP square stirrup; and
step six: making a composite spiral stirrup confinement model, and calculating the limit bearing capacity of the FRP composite spiral stirrup confined concrete column.

5. The compression design method for the FRP composite spiral stirrup confined concrete column according to claim 4, wherein in step five, a formula for calculating the effective lateral confinement stress of the FRP spiral stirrup is as follows:
$${f}_{1} {}^{'} = {k}_{e} \frac{2 {f}_{\text{fb}} {A}_{\text{f}}}{S {d}_{\text{s}}}$$
in the formula,
$${f}_{f b}$$
is a smaller value of the bending strength of the spiral stirrup and 0.004E _{ft} ^{,} and E _{ft} is the tensile modulus of elasticity of a reinforcement material;
A_{f} is the sectional area of the spiral stirrup;
S is the spacing between stirrups;
$${d}_{s}$$
is the diameter between the middle lines of the spiral stirrups;
kₑ is an effective confinement coefficient;
a formula for calculating the effective confinement coefficient kₑ of the FRP spiral stirrup is as follows:
$${k}_{e} = \frac{{A}_{e}}{{A}_{c c}} = \frac{1 - \frac{{S}^{'}}{2 {d}_{s}}}{1 - {ρ}_{c c}}$$
in the formula, ^{A}cc is the area of the concrete enclosed by the middle lines of the spiral stirrups and does not comprise the area of the longitudinal bars;
Aₑ is the effective confinement area of the effectively confined core concrete;
S′ is the clear distance between stirrups; and
p_{cc} is the ratio of the area of the longitudinal bars to the sectional core area.

6. The compression design method for the FRP composite spiral stirrup confined concrete column according to claim 4, wherein in step five, for the FRP square stirrup, the lateral confinement stress generated by the same in a horizontal plane is unevenly distributed; a confining force reaches the maximum at the longitudinal bar; an arch-shaped “ineffective confinementarea” between two adjacent longitudinal bars is in a quadratic parabola shape; the area of the parabola is
$$2$$
$${w}_{i}^{2} / 6 ,$$
wherein Wᵢ is the clear distance between the two adjacent longitudinal bars; the square stirrup also has an arch-shaped “ineffective confinement area” in the vertical direction;
so, for the FRP square stirrup, a process for calculating the effective lateral confinement stress f₂’ is as follows:
$${f}_{2}^{'} = \frac{{f}_{1 \text{x}}^{'} + {f}_{1 \text{y}}^{'}}{2}$$
wherein,
$${f}_{1 \text{x}}^{'} = {k}_{\text{e}} {ρ}_{\text{x}} {f}_{\text{fb}} = {k}_{e} \frac{{A}_{\text{sx}}}{S {d}_{c}} {f}_{\text{fb}}$$
$${f}_{\text{ly}}^{'} = {k}_{\text{e}} {ρ}_{\text{y}} {f}_{\text{fb}} = {k}_{e} \frac{{A}_{\text{sy}}}{S {b}_{c}} {f}_{\text{fb}}$$
in the formula, f_{lX}’ is an effective lateral confinement stress in an x direction;
f_{ly}’ is an effective lateral confinement stress in a y direction;
Aₛₓ is the total area of the stirrup in the x direction;
A_{sy} is the total area of the stirrup in the y direction;
b_{c} and d_{c}, are distances of centerlines of the rectangular stirrup in two directions, respectively, where
$${b}_{c} \geq {d}_{c} ;$$
a formula for calculating the effective confinement coefficient kₑ of the FRP square stirrup is as follows:
$${k}_{e} = \frac{{A}_{e}}{{A}_{c c}} = \frac{( 1 - {\sum }_{i = 1}^{n} \frac{{w}_{i}^{2}}{6 {b}_{c} {d}_{c}} ) ( 1 - \frac{{S}^{'}}{2 {b}_{c}} ) ( 1 - \frac{{S}^{'}}{2 {d}_{c}} )}{\left(1 - {ρ}_{c c}\right)}$$
in the formula, n the number of the longitudinal bars.

7. The compression design method for the FRP composite spiral stirrup confined concrete column according to claim 4, wherein in step six, when the composite spiral stirrup confinement model is made, in order to accurately reflect the actual confining effect of each stirrup, a composite spiral stirrup confinement area is divided into a dual confinement area and a single confinement area to accurately reflect the actual confining effect of each stirrup, wherein
the dual confinement area is an area inside the spiral stirrup, and the single confinement area is an area from the spiral stirrup to the square stirrup;
a peak stress expression of the concrete in the dual confinement area is as follows:
$${f}_{c c 1} = {f}_{c o} \left(1.0 + 3.897 {( \frac{{{f}^{'}}_{d}}{{f}_{c o}} )}^{0.737}\right)$$
in the formula, ƒ_{cc1} is the peak stress of the concrete in the dual confinement area;
ƒ_{co} is the strength of confined concrete;
ƒ_{d}’ is the sum of the effective lateral confinement stresses of the spiral stirrup and the rectangular stirrup;
a peak stress expression of the concrete in the single confinement area is as follows:
$${f}_{c c 2} = {f}_{c o} \left(2.254 \sqrt{1 + \frac{7.94 {f}_{2} '}{{f}_{c o}} -} 2 \frac{{f}_{2} '}{{f}_{c o}} - 1.254\right)$$
in the formula, ƒ_{cc2} is the peak stress of the concrete in the single confinement area;
ƒ_{co} is the strength of the confined concrete;
ƒ₂’ is an effective lateral confinement stress of the FRP rectangular stirrup;
finally, a formula for calculating the bearing capacity of the FRP composite spiral stirrup confined concrete column is as follows:
$${P}_{0} = {f}_{c c 1} \left({A}_{1} - {n}_{1} A {}_{b a r}\right) + {f}_{c c 2} ( {A}_{2} - {n}_{2} {A}_{b a r} ) + n {ε}_{b a r} {E}_{b a r} {A}_{b a r}$$
in the formula, P₀ is the bearing capacity of the FRP composite spiral stirrup confined concrete column;
fcc1 is the peak stress of the concrete in the dual confinement area;
A₁ is the area of the dual confinement area;
n₁ is the number of the longitudinal bars of the dual confinement area;
ƒ_{cc2} is the peak stress of the con concrete in the single confinement area;
A₂ is the area of the single confinement area;
n₂ is the number of the longitudinal bars in the single confinement area;
A_{bar} is the sectional area of a single longitudinal bar;
n is the total number of the longitudinal bars;
ε_{bar} is the limit compressive strain of the FRP bar; and
E_{bar} is the modulus of elasticity of the FRP bar.

8. The compression design method for the FRP composite spiral stirrup confined concrete column according to claim 7, wherein the values of the limit compressive strains E_{bar} of the FRP bar are taken as 1.3%, 1.2%, and 0.7% according to the slenderness ratios of 6, 10, and 15, and the values of other slenderness ratios are taken according to interpolation.

9. The compression design method for the FRP composite spiral stirrup confined concrete column according to claim 4, wherein the FRP square stirrup and the FRP spiral stirrup use one or more of Glass Fiber Reinforced Polymer/Plastic (GFRP) bars, Carbon Fiber Reinforced Polymer/Plastic (CFRP) bars, Basalt Fiber Reinforced Polymer/Plastic (BFRP) bars, and Aramid Fiber Reinforced Polymer/Plastic (AFRP) bars.

10. The compression design method for the FRP composite spiral stirrup confined concrete column according to claim 4, wherein the longitudinal bars use one of steel bars, the GFRP bars, the CFRP bars, the BFRP bars, and the AFRP bars, or mixed bars of the steel bars and FRP bars.

11. The compression design method for the FRP composite spiral stirrup confined concrete column according to claim 9, wherein in step five, a formula for calculating the effective lateral confinement stress of the FRP spiral stirrup is as follows:
$${f}_{1} {}^{'} = {k}_{e} \frac{2 {f}_{\text{fb}} {A}_{\text{f}}}{S {d}_{\text{s}}}$$
in the formula, f _{fb} is a smaller value of the bending strength of the spiral stirrup and 0.004E _{ft} ^{,} and E _{ft} is the tensile modulus of elasticity of a reinforcement material;
A_{f} is the sectional area of the spiral stirrup;
S is the spacing between stirrups;
d_{c}, is the diameter between the middle lines of the spiral stirrups;
kₑ is an effective confinement coefficient;
a formula for calculating the effective confinement coefficient kₑ of the FRP spiral stirrup is as follows:
$${k}_{e} = \frac{{A}_{e}}{{A}_{c c}} = \frac{1 - \frac{{S}^{'}}{2 {d}_{s}}}{1 - {ρ}_{c c}}$$
in the formula, A_{cc} is the area of the concrete enclosed by the middle lines of the spiral stirrups and does not comprise the area of the longitudinal bars;
Aₑ is the effective confinement area of the effectively confined core concrete;
S′ is the clear distance between stirrups; and
P_{cc} is the ratio of the area of the longitudinal bars to the sectional core area.

12. The compression design method for the FRP composite spiral stirrup confined concrete column according to claim 10, wherein in step five, a formula for calculating the effective lateral confinement stress of the FRP spiral stirrup is as follows:
$${f}_{1} {}^{'} = {k}_{e} \frac{2 {f}_{\text{fb}} {A}_{\text{f}}}{S {d}_{\text{s}}}$$
in the formula, f_{fb} is a smaller value of the bending strength of the spiral stirrup and 0.004E _{ft} ^{,} and E _{ft} is the tensile modulus of elasticity of a reinforcement material;
A_{f} is the sectional area of the spiral stirrup;
S is the spacing between stirrups;
dₛ, is the diameter between the middle lines of the spiral stirrups;
kₑ is an effective confinement coefficient;
a formula for calculating the effective confinement coefficient kₑ of the FRP spiral stirrup is as follows:
$${k}_{e} = \frac{{A}_{e}}{{A}_{c c}} = \frac{1 - \frac{{S}^{'}}{2 {d}_{s}}}{1 - {ρ}_{c c}}$$
in the formula, A_{cc} is the area of the concrete enclosed by the middle lines of the spiral stirrups and does not comprise the area of the longitudinal bars;
Aₑ is the effective confinement area of the effectively confined core concrete;
S′ is the clear distance between stirrups; and
p_{cc} is the ratio of the area of the longitudinal bars to the sectional core area.

13. The compression design method for the FRP composite spiral stirrup confined concrete column according to claim 9, wherein in step five, for the FRP square stirrup, the lateral confinement stress generated by the same in a horizontal plane is unevenly distributed; a confining force reaches the maximum at the longitudinal bar; an arch-shaped “ineffective confinementarea” between two adjacent longitudinal bars is in a quadratic parabola shape; the area of the parabola is
$${w}_{i}^{2} / 6 ,$$
wi′16, wherein Wᵢ is the clear distance between the two adjacent longitudinal bars; the square stirrup also has an arch-shaped “ineffective confinement area” in the vertical direction;
so, for the FRP square stirrup, a process for calculating the effective lateral confinement stress f₂’ is as follows:
$${f}_{2}^{'} = \frac{{f}_{1 \text{x}}^{'} + {f}_{1 \text{y}}^{'}}{2}$$
wherein,
$${f}_{1 \text{x}}^{{}^{1}} = {k}_{\text{e}} {ρ}_{\text{x}} {f}_{\text{fb}} = {k}_{\text{e}} \frac{{A}_{\text{sx}}}{S {d}_{\text{c}}} {f}_{\text{fb}}$$
$${f}_{\text{ly}}^{'} = {k}_{\text{e}} {ρ}_{\text{x}} {f}_{\text{fb}} = {k}_{\text{e}} \frac{{A}_{\text{sy}}}{S {d}_{\text{c}}} {f}_{\text{fb}}$$
in the formula, fₗₓ’ is an effective lateral confinement stress in an x direction;
f_{ly}’ is an effective lateral confinement stress in a y direction;
Aₛₓ is the total area of the stirrup in the x direction;
A_{sy} is the total area of the stirrup in the y direction;
b_{c} and d_{c}, are distances of centerlines of the rectangular stirrup in two directions, respectively, where b_{c} ≥d_{c};
a formula for calculating the effective confinement coefficient kₑ of the FRP square stirrup is as follows:
$${k}_{\text{e}} = \frac{{A}_{\text{e}}}{{A}_{\text{cc}}} = \frac{\left(1 - {\sum }_{i = 1}^{n} \frac{{w}_{i}^{2}}{6 {b}_{\text{c}} {d}_{\text{c}}}\right) \left(1 - \frac{{S}^{{}^{1}}}{2 {b}_{\text{c}}}\right) \left(1 - \frac{{S}^{{}^{1}}}{2 {d}_{\text{c}}}\right)}{\left(1 - {ρ}_{\text{cc}}\right)}$$
in the formula, n the number of the longitudinal bars.

14. The compression design method for the FRP composite spiral stirrup confined concrete column according to claim 10, wherein in step five, for the FRP square stirrup, the lateral confinement stress generated by the same in a horizontal plane is unevenly distributed; a confining force reaches the maximum at the longitudinal bar; an arch-shaped “ineffective confinementarea” between two adjacent longitudinal bars is in a quadratic parabola shape; the area of the parabola is
$${w}_{i}^{2} / 6 ,$$
wi′16, wherein Wᵢ is the clear distance between the two adjacent longitudinal bars; the square stirrup also has an arch-shaped “ineffective confinement area” in the vertical direction;
so, for the FRP square stirrup, a process for calculating the effective lateral confinement stress f₂’ is as follows:
$${f}_{2}^{1} = \frac{{f}_{\text{lx}}^{1} + {f}_{\text{ly}}^{1}}{2}$$
wherein,
$${f}_{1 \text{x}}^{{}^{1}} = {k}_{\text{e}} {ρ}_{\text{x}} {f}_{\text{fb}} = {k}_{\text{e}} \frac{{A}_{\text{sx}}}{S {d}_{\text{c}}} {f}_{\text{fb}}$$
$${f}_{1 \text{x}}^{{}^{1}} = {k}_{\text{e}} {ρ}_{\text{x}} {f}_{\text{fb}} = {k}_{\text{e}} \frac{{A}_{\text{sx}}}{S {d}_{\text{c}}} {f}_{\text{fb}}$$
in the formula, fₗₓ’ is an effective lateral confinement stress in an x direction;
f_{ly}’ is an effective lateral confinement stress in a y direction;
Aₛₓ is the total area of the stirrup in the x direction;
Asy is the total area of the stirrup in the y direction;
b_{c} and d_{c}, are distances of centerlines of the rectangular stirrup in two directions, respectively, where b_{c} ≥ d_{c};
a formula for calculating the effective confinement coefficient kₑ of the FRP square stirrup is as follows:
$${k}_{\text{e}} = \frac{{A}_{\text{e}}}{{A}_{\text{cc}}} = \frac{\left(1 - {\sum }_{i = 1}^{n} \frac{{w}_{i}^{2}}{6 {b}_{\text{c}} {d}_{\text{c}}}\right) \left(1 - \frac{{S}^{{}^{1}}}{2 {b}_{\text{c}}}\right) \left(1 - \frac{{S}^{{}^{1}}}{2 {d}_{\text{c}}}\right)}{\left(1 - {ρ}_{\text{cc}}\right)}$$
in the formula, n the number of the longitudinal bars.

15. The compression design method for the FRP composite spiral stirrup confined concrete column according to claim 9, wherein in step six, when the composite spiral stirrup confinement model is made, in order to accurately reflect the actual confining effect of each stirrup, a composite spiral stirrup confinement area is divided into a dual confinement area and a single confinement area to accurately reflect the actual confining effect of each stirrup, wherein
the dual confinement area is an area inside the spiral stirrup, and the single confinement area is an area from the spiral stirrup to the square stirrup;
a peak stress expression of the concrete in the dual confinement area is as follows:
$${f}_{c c 1} = {f}_{c o} \left(1.0 + 3.897 {\left(\frac{{f}_{d}^{{}^{1}}}{{f}_{c o}}\right)}^{0.737}\right)$$
in the formula, f_{ccl} is the peak stress of the concrete in the dual confinement area;
f_{co} is the strength of confined concrete;
f_{d}’ is the sum of the effective lateral confinement stresses of the spiral stirrup and the rectangular stirrup;
a peak stress expression of the concrete in the single confinement area is as follows:
$${f}_{c c 2} = {f}_{c o} \left(2.254 \sqrt{1 + \frac{7.94 {f}_{2} '}{{f}_{c o}}} - 2 \frac{{f}_{2} '}{{f}_{c o}} - 1.254\right)$$
in the formula, f_{cc2} is the peak stress of the concrete in the single confinement area;
f_{co} is the strength of the confined concrete;
f₂’ is an effective lateral confinement stress of the FRP rectangular stirrup;
finally, a formula for calculating the bearing capacity of the FRP composite spiral stirrup confined concrete column is as follows:
$${P}_{0} = {f}_{c c 1} \left({A}_{1} - {n}_{1} {A}_{b a r}\right) + {f}_{c c 2} \left({A}_{2} - {n}_{2} {A}_{b a r}\right) + n {ε}_{b a r} {E}_{b a r} {A}_{b a r}$$
in the formula, P₀ is the bearing capacity of the FRP composite spiral stirrup confined concrete column;
fcc1 is the peak stress of the concrete in the dual confinement area;
A₁ is the area of the dual confinement area;
n₁ is the number of the longitudinal bars of the dual confinement area;
f_{cc2} is the peak stress of the con concrete in the single confinement area;
A₂ is the area of the single confinement area;
n₂ is the number of the longitudinal bars in the single confinement area;
A_{bar} is the sectional area of a single longitudinal bar;
n is the total number of the longitudinal bars;
E_{bar} is the limit compressive strain of the FRP bar; and
E_{bar} is the modulus of elasticity of the FRP bar.

16. The compression design method for the FRP composite spiral stirrup confined concrete column according to claim 10, wherein in step six, when the composite spiral stirrup confinement model is made, in order to accurately reflect the actual confining effect of each stirrup, a composite spiral stirrup confinement area is divided into a dual confinement area and a single confinement area to accurately reflect the actual confining effect of each stirrup, wherein
the dual confinement area is an area inside the spiral stirrup, and the single confinement area is an area from the spiral stirrup to the square stirrup;
a peak stress expression of the concrete in the dual confinement area is as follows:
$${f}_{c c 1} = {f}_{c o} \left(1.0 + 3.897 {\left(\frac{{f}_{d}^{{}^{1}}}{{f}_{c o}}\right)}^{0.737}\right)$$
in the formula, ƒ_{cc1} is the peak stress of the concrete in the dual confinement area;
f_{co} is the strength of confined concrete;
f_{d}’ is the sum of the effective lateral confinement stresses of the spiral stirrup and the rectangular stirrup;
a peak stress expression of the concrete in the single confinement area is as follows:
$${f}_{c c 2} = {f}_{c o} \left(2.254 \sqrt{1 + \frac{7.94 {f}_{2} '}{{f}_{c o}}} - 2 \frac{{f}_{2} '}{{f}_{c o}} - 1.254\right)$$
in the formula, f_{cc2} is the peak stress of the concrete in the single confinement area;
f_{co} is the strength of the confined concrete;
f₂’ is an effective lateral confinement stress of the FRP rectangular stirrup;
finally, a formula for calculating the bearing capacity of the FRP composite spiral stirrup confined concrete column is as follows:
$${P}_{0} = {f}_{c c 1} \left({A}_{1} - {n}_{1} {A}_{b a r}\right) + {f}_{c c 2} \left({A}_{2} - {n}_{2} {A}_{b a r}\right) + n {ε}_{b a r} {E}_{b a r} {A}_{b a r}$$
in the formula, P₀ is the bearing capacity of the FRP composite spiral stirrup confined concrete column;
fccl is the peak stress of the concrete in the dual confinement area;
A₁ is the area of the dual confinement area;
n₁ is the number of the longitudinal bars of the dual confinement area;
f_{cc2} is the peak stress of the con concrete in the single confinement area;
A₂ is the area of the single confinement area;
n₂ is the number of the longitudinal bars in the single confinement area;
A_{bar} is the sectional area of a single longitudinal bar;
n is the total number of the longitudinal bars;
E_{bar} is the limit compressive strain of the FRP bar; and
E_{bar} is the modulus of elasticity of the FRP bar.

17. The compression design method for the FRP composite spiral stirrup confined concrete column according to claim 15, wherein the values of the limit compressive strains E_{bar} of the FRP bar are taken as 1.3%, 1.2%, and 0.7% according to the slenderness ratios of 6, 10, and 15, and the values of other slenderness ratios are taken according to interpolation.

18. The compression design method for the FRP composite spiral stirrup confined concrete column according to claim 16, wherein the values of the limit compressive strains E_{bar} of the FRP bar are taken as 1.3%, 1.2%, and 0.7% according to the slenderness ratios of 6, 10, and 15, and the values of other slenderness ratios are taken according to interpolation.
